(19) United States
(12) Patent Application Publication
(10) Pub. No.: US 2026/0339167 A1
(43) Pub. Date: Oct. 29, 2026

(54) LENS DRIVING DEVICE, CAMERA MODULE, AND OPTICAL INSTRUMENT

(71) Applicant: LG INNOTEK CO., LTD., Seoul (KR)

(72) Inventor: Dae Young KIM, Seoul (KR)

(21) Appl. No.: 19/107,773

(22) PCT Filed: Jul. 27, 2023
(86) PCT No.: PCT/KR2023/010967

§ 371 Date: Feb. 28, 2025

(30) Foreign Application Priority Data
Aug. 30, 2022 (KR) 10-2022-0109519

(51) Int. Cl. G03B 13/36

(52) U.S. Cl. CPC G03B 13/36

(57) ABSTRACT

The present embodiment comprises: a fixing part; a movement part arranged inside the fixing part; a driving magnet arranged on the movement part; a coil arranged on the fixing part to correspond to the driving magnet; and a ball arranged between the fixing part and the movement part, wherein the ball guides the movement part to move in an optical axial direction with respect to the fixing part, the fixing part comprises a first side plate and a second side plate arranged on the opposite sides as each other, and a third side plate and a fourth side plate which connect the first and the second side plate and are arranged on the opposite sides as each other, the movement part comprises a first side surface and a second side surface arranged on the opposite sides as each other, and a third side surface and a fourth side surface which connect the first side surface and the second side surface and are arranged on the opposite sides as each other, the first through fourth side plates facing the first through fourth side surfaces, the driving magnet moves the movement part in the optical axial direction via interaction with the coil, and comprises a first driving magnet arranged on the first side surface of the movement part, and a second driving magnet arranged on the third side surface of the movement part, and the ball comprises a first ball arranged in a first corner region at which the first side plate and the fourth side plate of the fixing part are connected, and a second ball arranged in a second corner region at which the second side plate and the third side plate of the fixing part are connected.

### TECHNICAL FIELD

The present embodiment relates to a lens driving device.

### BACKGROUND ART

A camera device is a device that photographs a picture or video of a subject, and is installed in optical instruments such as smartphones, drones, and vehicles.

Camera devices require an auto focus (AF) function that automatically adjusts the focus according to the distance between the camera device and the subject. In addition, optical image stabilization (OIS) function that compensates for image shaking caused by the user's movement is required to improve image quality.

However, as the resolution of image sensors has increased in recent years, the lens diameter has increased, and the driving force required to move the lens to perform autofocus or image stabilization functions is increasing.

### DETAILED DESCRIPTION OF THE INVENTION

### Technical Subject

The present embodiment is intended to provide a lens driving device that provides increased driving force within a limited size.

### Technical Solution

A lens driving device according to the present embodiment comprises: a fixing part; a movement part being arranged inside the fixing part; a driving magnet being arranged on the movement part; a coil being arranged on the fixing part to correspond to the driving magnet; and a ball being arranged between the fixing part and the movement part, wherein the ball guides the movement part to move in an optical axial direction against the fixing part, wherein the fixing part includes a first side plate and a second side plate being arranged opposite to each other, and a third side plate and a fourth side plate connecting the first and second side plates and being arranged opposite to each other, wherein the movement part comprises a first side surface and a second side surface being arranged opposite to each other, and a third side surface and a fourth side surface connecting the first side surface and the second side surface being arranged opposite to each other, wherein the first to fourth side plates face the first to fourth side surfaces, wherein the driving magnet moves the movement part in the optical axial direction via the interaction with the coil, wherein the driving magnet includes a first driving magnet being arranged on the first side surface of the movement part, and a second driving magnet being arranged on the third side surface of the movement part, and wherein the ball includes a first ball being arranged in a first corner region where the first side plate and the fourth side plate of the fixing part are connected, and a second ball being arranged in a second corner region where the second side plate and the third side plate of the fixing part are connected.

The first side plate includes a first protruded portion being protruded from an inner surface of the first side plate, the first protruded portion includes a groove, and the first ball is arranged in the groove of the first side plate.

The third side plate includes a second protruded portion being protruded from an inner surface of the third side plate, the second protruded portion includes a groove, and the second ball is arranged in the groove of the third side plate.

The first side surface includes a first groove being formed inwardly of the moving part on the surface of the first side surface, and the third side surface includes a second groove being formed inwardly of the moving part on the surface of the third side surface.

The first protruded portion of the first side plate is arranged in the first groove of the first side surface, and the second protruded portion of the third side plate is arranged in the second groove of the third side surface.

The first ball is in contact with the first protruded portion of the first side plate and the first groove of the first side surface, and the second ball is in contact with the second protruded portion of the third side plate and the second groove of the third side surface.

It includes a first yoke being arranged on the outside of the fixed portion and overlapped with the first side plate in a direction perpendicular to the optical axis direction, and a second yoke being arranged on the outside of the fixed portion and overlapped with the third side plate in a direction perpendicular to the optical axis direction.

The first ball includes a plurality of first balls, the second ball includes a plurality of second balls, the plurality of first balls is arranged in the optical axis direction, and the plurality of second balls is arranged in the optical axis direction.

A lens driving device according to a first embodiment comprises: a fixing part; a movement part being arranged inside the fixing part; a driving magnet being arranged on the movement part; a coil being arranged on the fixing part to correspond to the driving magnet; and a ball being arranged between the fixing part and the movement part, wherein the ball guides the movement part to move in an optical axial direction against the fixing part, wherein the fixing part includes a first side plate and a second side plate being arranged opposite to each other, and a third side plate and a fourth side plate connecting the first and second side plates and being arranged opposite to each other, wherein the movement part comprises a first side surface and a second side surface being arranged opposite to each other, and a third side surface and a fourth side surface connecting the first side surface and the second side surface being arranged opposite to each other, wherein the first to fourth side plates face the first to fourth side surfaces, wherein the driving magnet moves the movement part in the optical axial direction via the interaction with the coil, wherein the driving magnet includes a first driving magnet being arranged on the first side surface of the movement part, and a second driving magnet being arranged on the third side surface of the movement part, and wherein the ball includes a first ball being arranged in a first corner region where the first side plate and the third side plate of the fixing part are connected, and a second ball being arranged in a second corner region where the second side plate and the fourth side plate of the fixing part are connected.

The first side plate includes a protruded portion being protruded from the inner surface of the first side plate, and the second side plate includes a protruded portion being protruded from the inner surface of the second side plate.

The protruded portion of the first side plate and the protruded portion of the second side plate is rotational symmetrical with respect to an optical axis.

The protruded portion of the first side plate includes a groove, and the first ball is arranged in the groove of the protruded portion of the first side plate.

The first side surface includes a groove being inwardly recessed from an outer surface of the first side surface toward the inside of the movement part, and the second side surface includes a groove being inwardly recessed from an outer surface of the second side surface toward the inside of the movement part.

The protruded portion of the first side plate is arranged in the groove of the first side surface, and the protruded portion of the second side plate is arranged in the groove of the second side surface.

It includes a first yoke being arranged on an outside of the fixed portion and overlapping the first side plate in a direction perpendicular to the optical axis direction, and a second yoke being arranged on the outside of the fixed portion and overlapped with the second side plate in a direction perpendicular to the optical axis direction.

The center of the first yoke is overlapped with a first region of the movement part in a direction perpendicular to the optical axis direction, and the center of the second yoke is overlapped with a second region of the movement part in a direction perpendicular to the optical axis direction. A lens driving device according to a second embodiment comprises: a fixing part; a movement part being arranged inside the fixing part; a driving magnet being arranged on the movement part; a coil being arranged to correspond to the driving magnet being arranged on the fixing part; and a ball being arranged between the fixing part and the movement part, wherein the ball guides the movement part to move in an optical axis direction against the fixing part, wherein the fixing part includes a first side plate and a second side plate being arranged opposite to each other, and a third side plate and a fourth side plate connecting the first side plate and the second side plate and being arranged opposite to each other, wherein the movement part includes a first side surface and a second side surface being arranged opposite to each other, and a third side surface and a fourth side surface connecting the first side surface and the second side surface and arranged in opposite directions, wherein the first to fourth side plates face the first to fourth side surfaces, wherein the driving magnet moves the movement part in the optical axis direction through interaction with the coil, wherein the driving magnet includes a first driving magnet being arranged on the first side surface of the movement part, and a third driving magnet being arranged on the third side surface of the movement part, wherein the ball includes a first ball and a second ball being arranged in a corner region between the first side plate and the third side plate, and wherein the first ball and the second ball are arranged to be spaced apart from each other.

A camera device comprises: a printed circuit board; an image sensor being arranged on the printed circuit board; a lens driving device being arranged on the printed circuit board; and a lens being arranged in the lens driving device.

The optical instrument comprises: a main body; a display unit being arranged in the main body for displaying information; and a camera module being arranged in the main body for photographing at least one of an image and a photograph.

### Advantageous Effects

Through the present embodiment, there is an effect of increasing the AF driving force by arranging the driving magnet and the coil for driving the AF in both directions. In addition, through the present embodiment, there is an effect of increasing the AF driving force by arranging a plurality of driving magnets and coils for driving the AF. That is, when the heights of the cameras are the same, a higher AF driving force can be secured compared to a structure in which the driving magnets and coils for driving the AF are arranged in one direction.

### BRIEF DESCRIPTION OF DRAWINGS

FIG. 1 is a perspective view of a lens driving device according to the present embodiment.

FIG. 2 is a plan view of a lens driving device according to the present embodiment.

FIG. 3 is an exploded perspective view of a lens driving device according to the present embodiment.

FIG. 4 is a perspective view of a fixing part in a lens driving device according to the present embodiment.

FIG. 5 is a plan view of a fixing part in a lens driving device according to the present embodiment.

FIG. 6 is a perspective view of a movement part in a lens driving device according to the present embodiment.

FIG. 7 is a plan view of a movement part in a lens driving device according to the present embodiment.

FIG. 8 is an exploded perspective view of a lens driving device according to a first modified embodiment.

FIG. 9 is a plan view of a lens driving device according to a first modified embodiment.

FIG. 10 is a perspective view of a fixing part in a lens driving device according to a first modified embodiment.

FIG. 11 is a plan view of a fixing part in a lens driving device according to a first modified embodiment.

FIG. 12 is a perspective view of the movement part in a lens driving device according to a first modified embodiment.

FIG. 13 is a plan view of the movement part in a lens driving device according to a first modified embodiment.

FIG. 14 is a drawing illustrating a movement part tilting from a fixing part in a lens driving device according to a first modified embodiment.

FIG. 15 is a plan view of a lens driving device according to a second modified embodiment.

FIGS. 16 to 18 are diagrams for explaining the auto focus driving of a lens driving device according to the present embodiment. FIG. 16 is a cross-sectional view illustrating the appearance of a movement part in an initial state in which no current is applied to a first coil and a second coil. FIG. 17 is a cross-sectional view illustrating the appearance in which a movement part moves upward in an optical axis direction when a forward current is applied to a first coil and a second coil. FIG. 18 is a cross-sectional view illustrating the appearance in which a movement part moves downward in an optical axis direction with reference to the position of a movement part in FIG. 17 when a reverse current is applied to a first coil and a second coil.

FIG. 19 is an exploded perspective view of a camera device according to the present embodiment.

FIG. 20 is a perspective view of an optical instrument according to the present embodiment.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C. In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction with respect to one component may be included.

Hereinafter, a lens driving device according to the present embodiment is described with reference to the drawings.

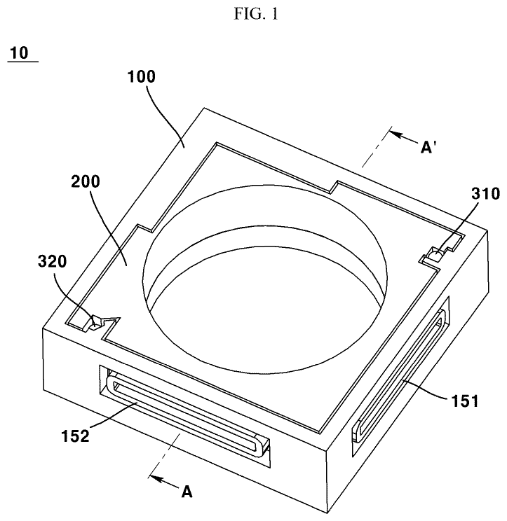

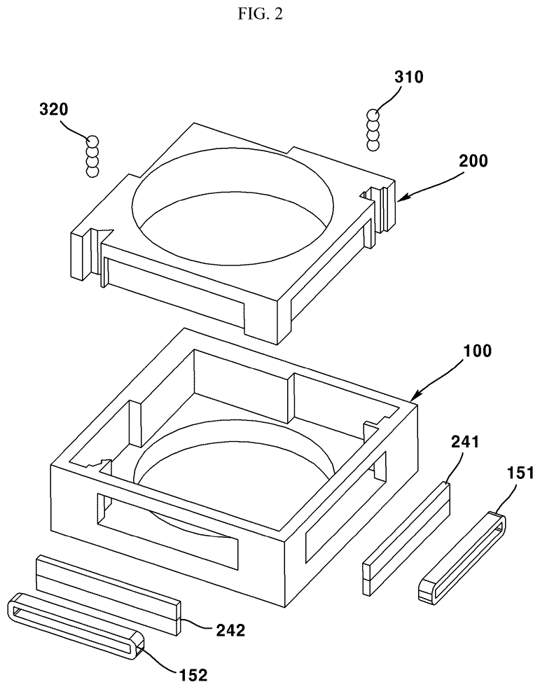

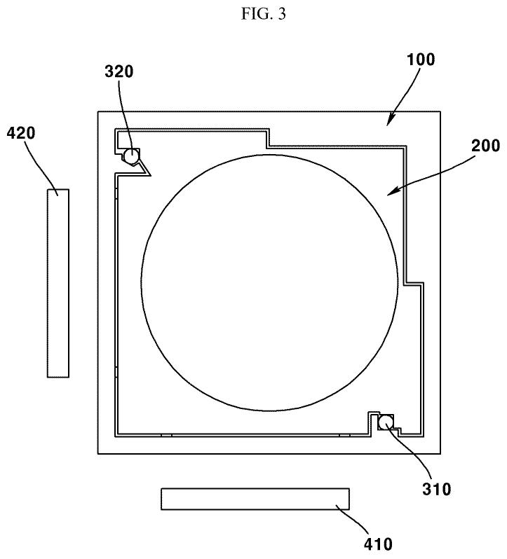

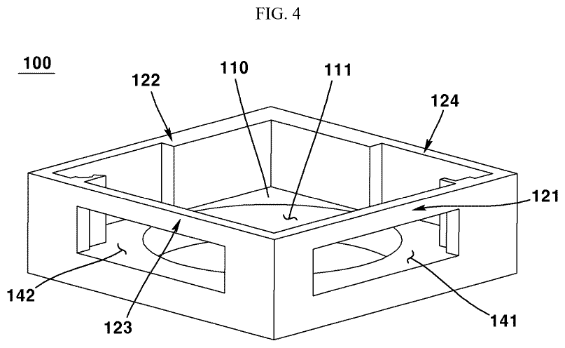

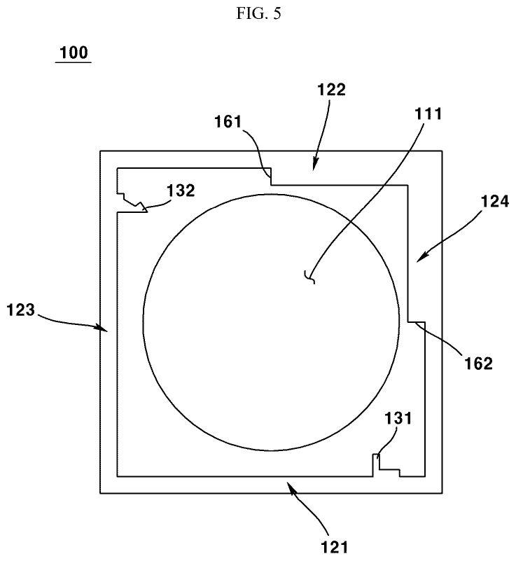

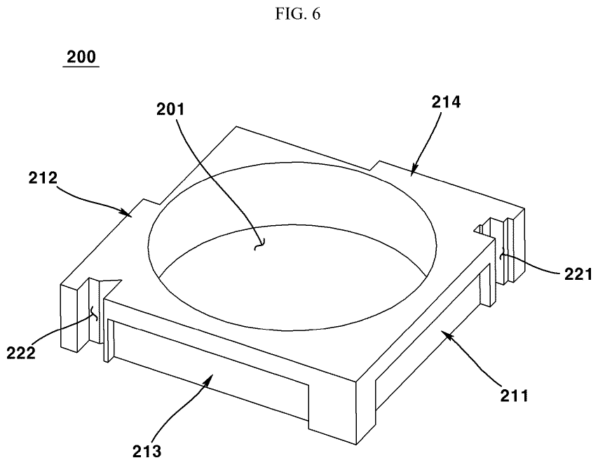

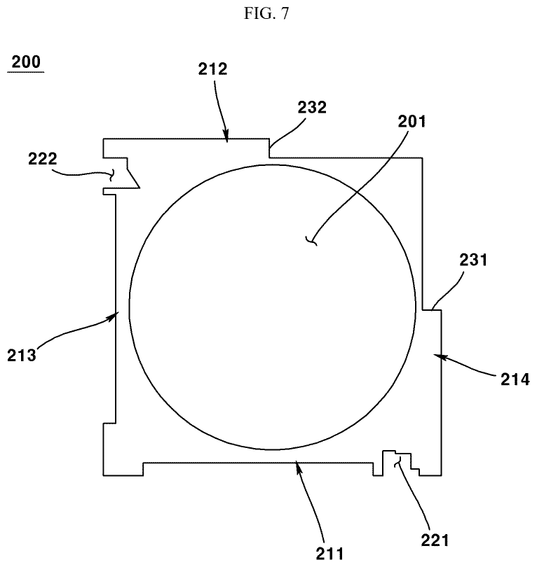

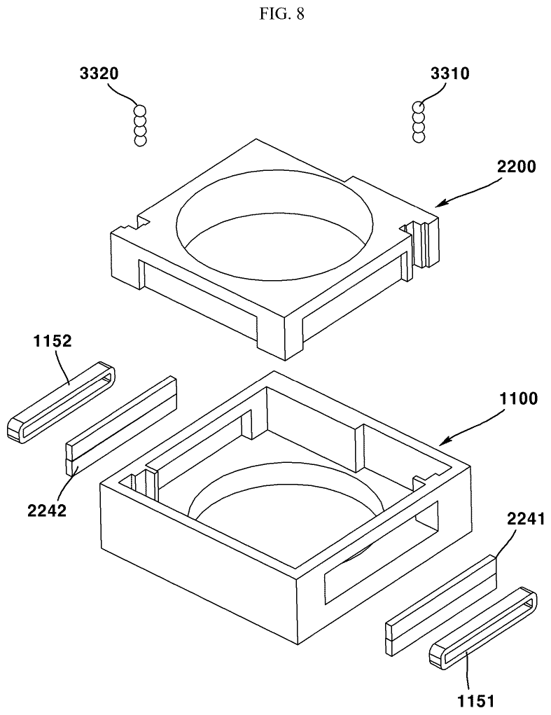

FIG. 1 is a perspective view of a lens driving device according to the present embodiment; FIG. 2 is a plan view of a lens driving device according to the present embodiment; FIG. 3 is an exploded perspective view of a lens driving device according to the present embodiment; FIG. 4 is a perspective view of a fixing part in a lens driving device according to the present embodiment; FIG. 5 is a plan view of a fixing part in a lens driving device according to the present embodiment; FIG. 6 is a perspective view of a movement part in a lens driving device according to the present embodiment; and FIG. 7 is a plan view of a movement part in a lens driving device according to the present embodiment.

The lens driving device may be a lens driving actuator. The lens driving device may be a voice coil motor (VCM). The lens driving device may be a lens driving motor. The lens driving device may include an AF module. The lens driving device may include an OIS module.

The lens driving device 10 according to the present embodiment may include a fixing part 100.

The fixing part 100 may be a stator. The fixing part 100 may be a relatively fixed part when the movement part 200 moves. The fixing part 100 may include a lower plate 110, a first side plate 121, a second side plate 122, a third side plate 123, and a fourth side plate 124. The first side plate 121, the second side plate 122, the third side plate 123, and the fourth side plate 124 may be arranged on the lower plate 110.

The lower plate 110 may include a lens hole 111. The lens hole 111 may be a hole penetrating the lower plate 110 in the optical axis direction. The lens hole 111 may be a hole having a circular cross-section. A lens may be placed in the lens hole 111.

The first side plate 121 may be a side surface of the fixing part 100. The first side plate 121 may be protruded from the upper surface of the lower plate 110. The first side plate 121 may be arranged on the opposite side of the second side plate 122. The first side plate 121 may be connected to the third side plate 123. The first side plate 121 may be connected to the fourth side plate 124. The first side plate 121 may include a hole 141. The hole 141 of the first side plate 121 may be a hole formed in a direction perpendicular to the optical axis direction. A first coil 151 may be arranged in the hole 141 of the first side plate 121. The hole 141 of the first side plate 121 may have a square shape.

The first side plate 121 may include a first protruded portion 131. The first protruded portion 131 may be protruded from an inner surface of the first side plate 121 toward an inner side of the fixing part 100. The first protruded portion 131 may include a step being recessed from an inner side of the fixing part 100 toward an outer side. The step of the first protruded portion 131 may include a plurality of steps. The first protruded portion 131 may include a groove. The groove of the first protruded portion 131 may be a groove in which a first ball 310, which will be described later, is arranged. The second side plate 122 may be a side surface of the fixing part 100.

The second side plate 122 may be protruded from an upper surface of the lower plate 110. The second side plate 122 may be arranged on an opposite side of the first side plate 121. The second side plate 122 may be connected to the third side plate 123. The second side plate 122 may be connected to the fourth side plate 124. The second side plate 122 may include a step 161 that is recessed from an inside toward the outside of the fixing part 100. The step 161 of the second side plate 122 may correspond to the step 232 of the second side surface 212 of the movement part 200. The third side plate 123 may be a side surface of the fixing part 100. The third side plate 123 may be protruded from an upper surface of the lower plate 110. The third side plate 123 may be arranged on an opposite side of the fourth side plate 124. The third side plate 123 may be connected to the first side plate 121. The third side plate 123 may be connected to the second side plate 122. The third side plate 123 may include a hole 142. The hole 142 of the third side plate 123 may be a hole formed in a direction perpendicular to the optical axis direction.

A second coil 152 may be placed in the hole of the third side plate 123. The hole of the third side plate 123 may have a square shape. The third side plate 123 may include a second protruded portion 132. The second protruded portion 132 may be protruded from an inner surface of the third side plate 123 toward an inner side of the fixing part 100. The second protruded portion 132 may include a groove. The groove of the second protruded portion 132 may be a groove in which a second ball 320, which will be described later, is arranged. The groove of the second protruded portion 132 may be a groove being recessed from the second side plate 122 toward an inner side of the fixing part 100. The groove of the second protruded portion 132 may be a groove in which the second ball 320 is arranged.

The fourth side plate 124 may be a side surface of the fixing part 100. The fourth side plate 124 may be protruded from an upper surface of the lower plate 110. The fourth side plate 124 may be arranged on an opposite side of the third side plate 123. The fourth side plate 124 may be connected to the first side plate 121. The fourth side plate 124 may be connected to the second side plate 122. The fourth side plate 124 may include a step 162 being recessed from an inside to an outside of the fixing part 100. The step 162 of the fourth side plate 124 may correspond to the step 231 of the fourth side surface 214 of the movement part 200.

A Hall sensor (not shown) may be arranged on the fixing part 100. The Hall sensor may be arranged on the first side plate 121. The Hall sensor may be arranged between the connection portion where the first side plate 121 and the third side plate 123 are connected and the first coil 151. In addition, the Hall sensor may be arranged on at least one of the first to fourth side plates 121 to 124. For example, the Hall sensor may be arranged at a corner portion of the fixing part 100 where the first side plate 121 and the third side plate 123 meet. For example, the Hall sensor may be arranged at a corner portion of the fixing part 100 where the second side plate 122 and the fourth side plate 124 meet. The Hall sensor may detect a relative position of the movement part 200 with respect to the fixing part 100. The Hall sensor can detect the relative position of the movement part 200 to the fixing part 100 through a sensing magnet (not shown). The sensing magnet can be arranged on the first side surface 211 of the movement part 200. The sensing magnet can be arranged at a position facing the Hall sensor. However, when the Hall sensor is arranged on the first side surface 211 of the movement part 200, the sensing magnet can be arranged on the first side plate 121. The lens driving device 10 according to the present embodiment can include the movement part 200.

The movement part 200 may be a movable part. The movable part may be a mover. The movement part 200 may be a mover. The movement part 200 may move against the fixing part 100. The movement part 200 may include an AF movable part. The movement part 200 may include an OIS movable part. The movement part 200 may move in an optical axis direction against the fixing part 100. The movement part 200 may move together with the OIS movable part in a direction perpendicular to the optical axis against the fixing part 100.

The movement part 200 may include a lens hole 201. The lens hole 201 of the movement part 200 may be a hole penetrating the movement part 200 in an optical axis direction. A lens may be arranged in the lens hole 201 of the movement part 200. The lens hole 201 of the movement part 200 may be overlapped with the lens hole 111 of the fixing part 100 in an optical axis direction.

The movement part 200 may include a first side surface 211. The first side surface 211 may face the first side plate 121. The first side surface 211 may be overlapped with the first side plate 121 in a direction perpendicular to the first side plate 121 and the optical axis direction. The first side surface 211 may be overlapped with the first yoke 410 in a direction perpendicular to the first yoke 410 and the optical axis direction. The first side surface 211 may be arranged in a direction opposite to the second side surface 212. The first side surface 211 may be connected to a third side surface 213. The first side surface 211 may be connected to a fourth side surface 214.

The first side surface 211 may include a first groove 221. The first groove 221 may be arranged at a position corresponding to the first protruded portion 131 of the first side plate 121. The first protruded portion 131 may be arranged in the first groove 221. A first ball 310 may be arranged in the first groove 221. The first groove 221 may be in contact with the first ball 310. The first groove 221 may be in two-point contact with the first ball 310. A driving magnet may be arranged in the first side surface 211. A first driving magnet 241 may be arranged in the first side surface 211. The first driving magnet 241 may be coupled to the first side surface 211. The first driving magnet 241 may be coupled to the first side surface 211. The first driving magnet 241 may be coupled to the first side surface 211 by an adhesive.

The movement part 200 may include a second side surface 212. The second side surface 212 may be arranged in a direction opposite to the first side surface 211. The second side surface 212 may be connected to the third side surface 213. The second side surface 212 may be connected to the fourth side surface 214. The second side surface 212 may include a step 232. The step 232 of the second side surface 212 may be a step being recessed from an outer surface of the second side surface 212 toward the inside of the movement part 200. The step 232 of the second side surface 212 may correspond to the step 161 of the second side plate 122.

The movement part 200 may include a third side surface 213. The third side surface 213 may face the third side plate 123. The third side surface 213 may be overlapped with the third side plate 123 in a direction perpendicular to the third side plate 123 and the optical axis direction. The third side surface 213 may be overlapped with the second yoke 420 in a direction perpendicular to the second yoke 420 and the optical axis direction. The third side surface 213 may be arranged in a direction opposite to the fourth side surface 214. The third side surface 213 may be connected to the first side surface 211. The third side surface 213 may be connected to the second side surface 212.

The third side surface 213 may include a second groove 222. The second groove 222 may be arranged at a position corresponding to the second protruded portion 132 of the third side plate 123. A second protruded portion 132 may be arranged in the second groove 222. A second ball 320 may be arranged in the second groove 222. The second groove 222 may be in contact with the second ball 320. The second groove 222 may be in two-point contact with the second ball 320. A driving magnet may be arranged on the third side surface 213. A second driving magnet 242 may be arranged on the third side surface 213. The second driving magnet 242 may be coupled to the third side surface 213. The second driving magnet 242 may be coupled to the third side surface 213 by an adhesive.

The movement part 200 may include a fourth side surface 214. The fourth side surface 214 may be arranged in a direction opposite to the third side surface 213. The fourth side surface 214 may be connected to a first side surface 211. The fourth side surface 214 may be connected to a second side surface 212. The fourth side surface 214 may include a step 231. The step 231 of the fourth side surface 214 may be a step being recessed from an outer surface of the fourth side surface 214 toward an inner side of the movement part 200. A step of the fourth side surface 214 may correspond to the step 162 of the fourth side plate 124.

The hall sensor (not shown) may be arranged on the movement part 200. The Hall sensor may be arranged on the first side surface 211. The Hall sensor may be arranged between a connection part to which the first side surface 211 and the third side surface 213 are connected and the first driving magnet 241. The Hall sensor may detect a relative position of the movement part 200 with respect to the fixing part 100. The Hall sensor may detect a relative position of the movement part 200 with respect to the fixing part 100 through a sensing magnet (not shown). A sensing magnet may be arranged on the first side plate 121 of the fixing part 100. The sensing magnet may be arranged at a position opposite to the Hall sensor. However, when the Hall sensor is arranged in the first side plate 121 of the fixing part 100, the sensing magnet may be arranged on the first side surface 211.

The lens driving device 10 according to the present embodiment may include balls 310 and 320.

The balls 310 and 320 may be AF balls. The balls 310 and 320 may support the movement part 200. The balls 310 and 320 may support the movement part 200 moving in an optical axis direction with respect to the fixing part 100. The balls 310 and 320 may guide the movement part 200 moving in an optical axis direction with respect to the fixing part 100. Each of the balls 310 and 320 may include a plurality of balls. A plurality of balls may include a first ball 310 and a second ball.

The first ball 310 may be arranged on the first side plate 121. The first ball 310 may be arranged between the first side plate 121 and the fourth side plate 124. The first ball 310 may be arranged in the groove of the first protruded portion 131. The first ball 310 may be arranged in a stepped region of the first protruded portion 131. The first ball 310 may be in contact with the first protruded portion 131. The first ball 310 may be in two-point contact with the first protruded portion 131. The first ball 310 may be arranged in the first groove 221 of the first side surface 211. The first ball 310 may be in two-point contact with the first groove 221. The first ball 310 may be in two-point contact with the first groove 221. The first ball 310 may be in contact with the first protruded portion 131 in the first groove 221. The first ball 310 may be arranged between the first protruded portion 131 and the first groove 221.

The first ball 310 may include a plurality of first balls 310. A plurality of first balls 310 may be arranged in an optical axis direction. A plurality of first balls 310 may have the same diameter. Each of a plurality of first balls 310 may have different diameters. Any one of a plurality of first balls 310 may have different diameters. A plurality of first balls 310 may have different diameters of any two of a plurality of first balls 310.

The second ball 320 may be arranged on the third side plate 123. The second ball 320 may be arranged between the second side plate 122 and the third side plate 123. The second ball 320 may be arranged in the groove of the second protruded portion 132. The second ball 320 may be arranged in the stepped region of the second protruded portion 132. The second ball 320 may be in contact with the second protruded portion 132. The second ball 320 may be in two-point contact with the second protected portion 132. The second ball 320 may be arranged in the second groove 222 of the third side surface 213. The second ball 320 may be in two-point contact with the second groove 222. The second ball 320 may be in two-point contact with the second groove 222. The second ball 320 may be in contact with the second protruded portion 132 in the second groove 222. The second ball 320 may be arranged between the second protruded portion 132 and the second groove 222.

The second ball 320 may include a plurality of second balls 320. A plurality of second balls 320 may be arranged in an optical axis direction. A plurality of second balls 320 may have the same diameter. Each of a plurality of second balls 320 may have different diameters. A plurality of second balls 320 may have different diameters.

The lens driving device 10 according to the present embodiment may include yoke 410 and 420.

The yoke 410 and 420 may be a metal plate. The yoke 410 and 420 may be a part of the cover of the lens driving device. In the drawing, the cover of the lens driving device 10 is omitted, but the yoke 410 and 420 may correspond to a part of the cover of the lens driving device 10. The yoke 410 and 420 may be extended from the cover of the lens driving device. The yoke 410 and 420 may be arranged to be overlapped with the driving magnets 241 and 242 in a direction perpendicular to the optical axis direction. The yoke 410 and 420 may be arranged outside the fixing part 100.

The yoke 410 and 420 may include a first yoke 410. The first yoke 410 may be arranged to be overlapped with the first side plate 121 of the fixing part 100 in a direction perpendicular to the optical axis direction. The yoke 410 and 420 may include a second yoke 420. The second yoke 420 may be arranged to be overlapped with the third side plate 123 of the fixing part 100 in a direction perpendicular to the optical axis direction.

The movement part 200 may move a predetermined distance in the direction of the first corner region by the magnetic force being applied between the first yoke 410 and the first driving magnet 241 and the magnetic force being applied between the second yoke 420 and the second driving magnet 242. The movement part 200 may be in close contact with the first corner region by the magnetic force applied between the first yoke 410 and the first driving magnet 241 and the magnetic force being applied between the second yoke 420 and the second driving magnet 242 inside the fixing part 100. Here, the first corner region may be a region in which the first side plate 121 and the third side plate 123 are connected. The first corner region may be a region between the first side plate 121 and the third side plate 123.

Since the movement part 200 is in close contact with the first corner region inside the fixing part 100, the movement part 200 may be stably supported by the first ball 310 and the second ball 320 being arranged between the movement part 200 and the fixing part 100.

Since the movement part 200 is in close contact with the first corner region inside the fixing part 100 and is supported by the first ball 310 and the second ball 320 of the movement part 200, the movement part 200 can move stably in an optical axis direction inside the fixing part 100. In addition, since the movement part 200 is driven by a driving force by the interaction between the first driving magnet 241 and the first coil 151 and a driving force by the interaction between the second driving magnet 242 and the second coil 151, it can be driven with a greater driving force than when it is driven by one driving magnet and one coil.

Hereinafter, the lens driving device according to the first modification will be described with reference to the drawings. The description of the same contents as those of the above embodiment in relation to the first modified embodiment may be omitted below.

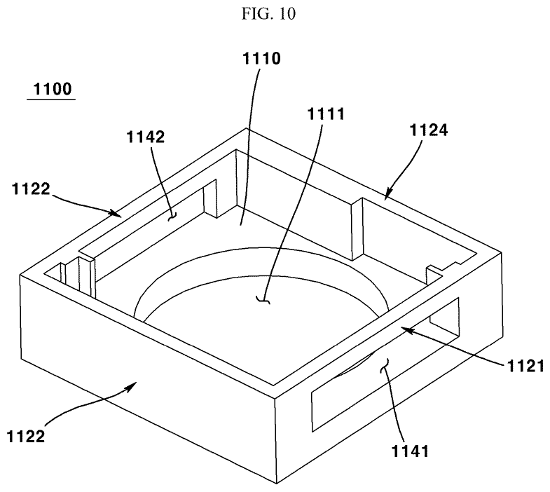

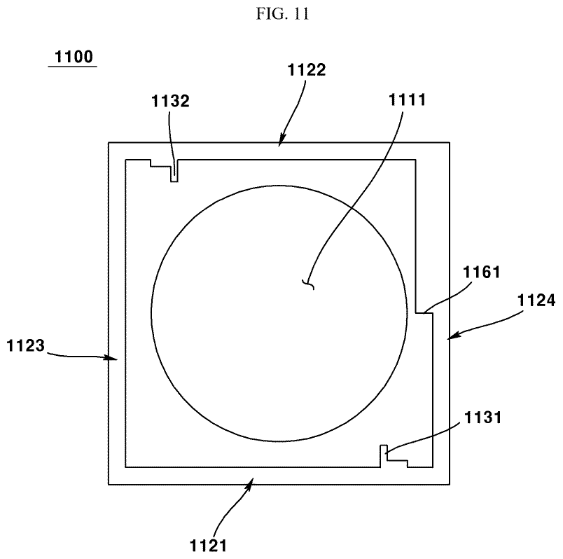

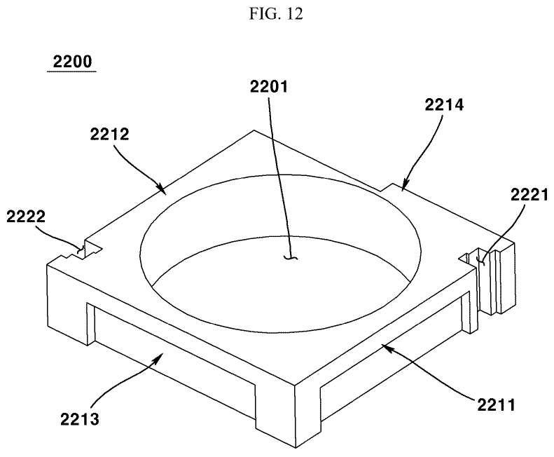

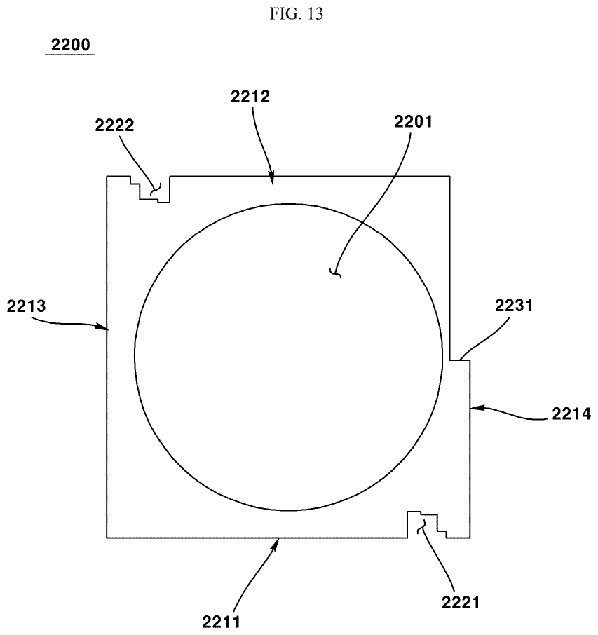

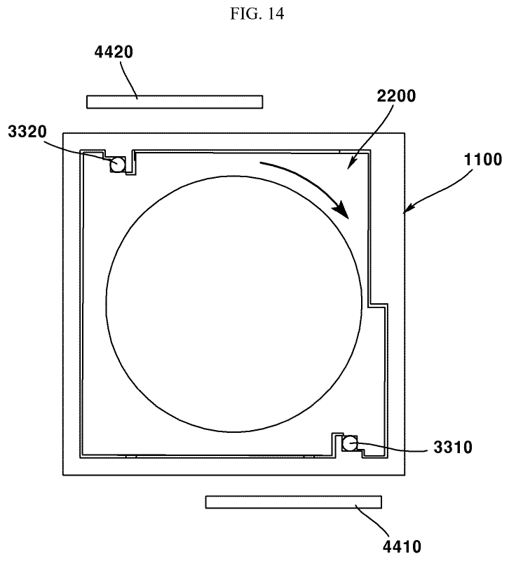

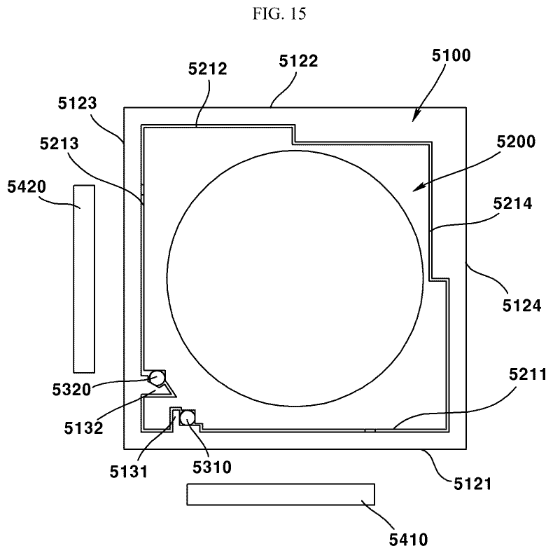

FIG. 10 is a perspective view of a fixing part in a lens driving device according to a first modified embodiment; FIG. 11 is a plan view of a fixing part in a lens driving device according to a first modified embodiment; FIG. 12 is a perspective view of the movement part in a lens driving device according to a first modified embodiment; FIG. 13 is a plan view of the movement part in a lens driving device according to a first modified embodiment; and FIG. 14 is a drawing illustrating a movement part tilting from a fixing part in a lens driving device according to a first modified embodiment.

The lens driving device 10 according to a first modified emergent may include a fixing part 1100.

The fixing part 1100 may include a first side plate 1121. The first side plate 1121 may be a side surface of the fixing part 1100. The first side plate 1121 may be protruded from an upper surface of the lower plate 1110. The first side plate 1121 may be arranged on an opposite side of the second side plate 1122. The first side plate 1121 may be connected to the third side plate 1123.

The first side plate 1121 may be connected to the fourth side plate 1124. The first side plate 1121 may include a hole. The hole 1141 of the first side plate 1121 may be a hole formed in a direction perpendicular to the optical axis direction. The first coil 1151 may be arranged in the hole 1141 of the first side plate 1121. The hole 1141 of the first side plate 1121 may have a rectangular shape. The first side plate 1121 may include a first protruded portion 1131. The first protruded portion 1131 may be protruded from the inner surface of the first side plate 1121 to the inside of the fixing part 1100. The first protruded portion 1131 may include a step recessed from the inside of the fixing part 1100 to the outside. The step of the first protruded portion 1131 may include a plurality of steps. The first protruded portion 1131 may include a groove. The groove of the first protruded portion 1131 may be a groove in which a first ball 3310 to be described later is arranged.

The second side plate 1122 may be a side surface of the fixing part 1100. The second side plate 1122 may be protruded from an upper surface of the lower plate 1110. The second side plate 1122 may be arranged on the opposite side of the first side plate 1121. The second side plate 1122 may be connected to the third side plate 1123. The second side plate 1122 may be connected to the fourth side plate 1124.

The second side plate 1122 may include a hole 1142. The hole 1142 of the second side plate 1122 may be a hole formed in a direction perpendicular to the optical axis direction. A second coil 1152 may be arranged in the hole of the second side plate 1122. The hole 1142 of the second side plate 1122 may have a rectangular shape. The second side plate 1122 may include a second protruded portion 1132. The second protruded portion 1132 may be protruded from the inner surface of the second side plate 1122 toward the inside of the fixing part 1100. The second protruded portion 1132 may include a groove. The groove of the second protruded portion 1132 may be a groove in which the second ball 332 is arranged. The groove of the second protruded portion 1132 may be a groove recessed in a direction from the second side plate 1122 toward the inside of the fixing part 1100. The second protruded portion 1132 may be rotational symmetry with respect to the first protruded portion 1131 with respect to an optical axis.

The third side plate 1123 may be a side surface of the fixing part 1100. The third side plate 1123 may be protruded from an upper surface of the lower plate 1110. The third side plate 1123 may be arranged on the opposite side of the fourth side plate 1124. The third side plate 1123 may be connected to the first side plate 1121. The third side plate 1123 may be connected to the second side plate 1122.

The fourth side plate 1124 may be a side surface of the fixing part 1100. The fourth side plate 1124 may be protruded from an upper surface of the lower plate 1110. The fourth side plate 1124 may be arranged on an opposite side of the third side plate 1123. The fourth side plate 1124 may be connected to the first side plate 1121. The fourth side plate 1124 may be connected to the second side plate 1122. The fourth side plate 1124 may include a step 1151 being recessed from the inside toward the outside of the fixing part 1100. The step 1151 of the fourth side plate 1124 may correspond to the step 1151 of the fourth side surface 1124 of the movement part.

The lens driving device 10 according to a first embodiment assembly may include a movement part 2200.

The movement part 2200 may include a first side surface 2211. The first side surface 2211 may face the first side plate 1121. The first side surface 2211 may be overlapped with the first side plate 1121 in a direction perpendicular to the optical axis direction with the first side plate 1121. The first side surface 2211 may be overlapped with the first yoke 4410 in a direction perpendicular to the optical axis direction. The first side surface 2211 may be arranged in a direction opposite to the second side surface 2212. The first side surface 2211 may be connected to a third side surface 2213. The first side surface 2211 may be connected to a fourth side surface 2214.

The first side surface 2211 may include a first groove 2221. The first groove 2221 may be arranged at a position corresponding to the first protruded portion 1131 of the first side plate 1121. The first protruded portion 1131 may be arranged in the first groove 2221. A first ball 3310 may be arranged in the first groove 2221. The first groove 2221 may be in contact with the first ball 3310. The first groove 2221 may be in two-point contact with the first ball 3310. Driving magnets may be arranged at the first side surface 2211. A first driving magnet 2241 may be arranged at the first side surface 2211. The first driving magnet 2241 may be coupled to the first side surface 2211. The first driving magnet 2241 may be coupled to the first side surface 2211. The first driving magnet 2241 may be coupled to the first side surface 2211 by an adhesive.

The movement part 2200 may include a second side surface 2212. The second side surface 2212 may face the second side plate 1122. The second side surface 2212 may be overlapped with the second side plate 1122 in a direction perpendicular to the second side plate 1122 and the optical axis direction. The second side surface 2212 may be overlapped with the second yoke 4420 in a direction perpendicular to the second yoke 4420 and the optical axis direction. The second side surface 2212 may be arranged in a direction opposite to the first side surface 2211. A second side surface 2212 may be connected to a third side surface 2213. A second side surface 2212 may be connected to a fourth side surface 2214.

The second side surface 2212 may include a second groove 2222. The second groove 2222 may be arranged at a position corresponding to the second protruded portion 1132 of the second side plate 1122. The second groove 2222 may be rotational symmetry with respect to the first groove 2221 and the optical axis. A second protruded portion 1132 may be arranged in the second groove 2222. A second ball 332 may be arranged in the second groove 2222. The second groove 2222 may be in contact with the second ball 3320. The second groove 2222 may be in two-point contact with the second ball 3320. A driving magnet may be arranged on the second side surface 2212. A second driving magnet 2242 may be arranged on the second side surface. The second driving magnet 2242 may be coupled to the second side surface 2212. The second driving magnet 2242 may be coupled to the second side surface 2212 by an adhesive.

The movement part 2200 may include a third side surface 2213. The third side surface 2213 may be arranged in a direction opposite to the fourth side surface 2214. The third side surface 2213 may be connected to the first side surface 2211. The third side surface 2213 may be connected to the second side surface 2212.

The movement part may include a fourth side surface 2214. The fourth side surface 2214 may be arranged in a direction opposite to the third side surface 2213. The fourth side surface 2214 may be connected to the first side surface 2211. The fourth side surface 2214 may be connected to the second side surface 2212. The fourth side surface 2214 may include a step 2231. The step 2231 of the fourth side surface 2214 may be a step being recessed from an outer surface of the fourth side surface 2214 toward the inside of the movement part. The step 2231 of the fourth side surface 2214 may correspond to the step 1161 of the fourth side plate 1124.

The lens driving device 10 according to the first modified embodiment may include balls 3310 and 3320.

The balls 3310 and 3320 may be AF balls. The balls 3310 and 3320 may support the movement part 2200. The balls 3310 and 3320 may support the movement part 2200 that moves in an optical axis direction with respect to the fixing part 1100. The balls 3310 and 3320 may include a plurality of balls. A plurality of balls may include a first ball 3310 and a second ball 3320.

The first ball 3310 may be arranged in the first side plate 1121. The first ball 3310 may be arranged in the groove of the first protruded portion 1131. The first ball 3310 may be arranged in a stepped region of the first protruded portion 1131. The first ball 3310 may be in contact with the first protruded portion 1131. The first ball 3310 may be in two-point contact with the first protruded portion 1131. The first ball 3310 may be arranged in the first groove 2221 of the first side surface 2211. The first ball 3310 may be in two-point contact with the first groove 2221. The first ball 3310 may be in contact with the first groove 2221. The first ball 3310 may be in contact with the first protruded portion 1131 in the first groove 2221.

The lens driving device 10 according to a first modified embodiment may include yokes 4410 and 4420.

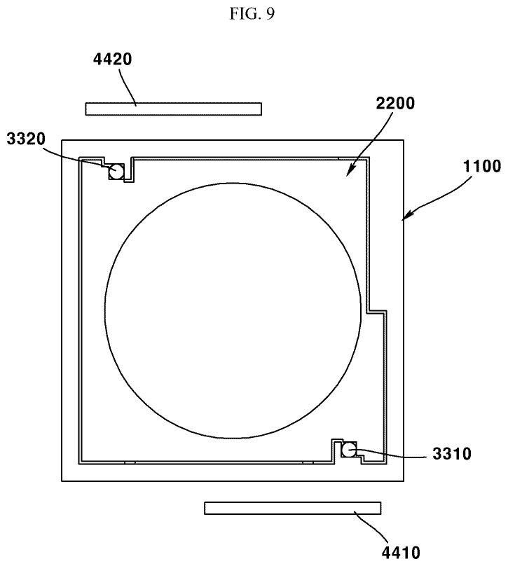

The yoke may include a first yoke 4410. The first yoke 4410 may be arranged to be overlapped with the first side plate 1121 of the fixing part 1100 in a direction perpendicular to an optical axis direction. Referring to FIG. 9, a center of the first yoke 4410 in a longitudinal direction may be arranged on the right side of the center of the lens hole.

The yoke may include a second yoke 4420. The second yoke 4420 may be arranged to be overlapped with the second side plate 1122 of the fixing part 1100 in a direction perpendicular to the optical axis direction. Referring to FIG. 9, a center of the second yoke 4420 in a longitudinal direction may be arranged at a left side of a center of the lens hole.

Referring to FIG. 14, the movement part 2200 may be tilted about an optical axis in the fixing part 1100 by the magnetic force between the first driving magnet 2241 and the first yoke 4410 and the magnetic force between the second driving magnet 2242 and the second yoke 4420. The movement part 2200 may be tilted with respect to the optical axis by the magnetic force applied between the first yoke 4410 and the first driving magnet 2241 and the magnetic force applied between the second yoke 4420 and the second driving magnet 2242. The movement part 2200 may be in close contact with the first ball 3310 and the second ball 332 by the magnetic force applied between the first yoke 4410 and the first driving magnet 2241 and the magnetic force applied between the second yoke 4420 and the second driving magnet 2242. The fixing part 1100 may be in close contact with the first ball 3310 and the second ball 3320. Accordingly, the movement part 2200 may be stably supported by the first ball 3310 and the second ball 3320, and the movement part 2200 may be stably moved in an optical axis direction inside the fixing part 1100. In addition, since the movement part 2200 is driven by the driving force by the interaction between the first driving magnet 2241 and the first coil 1151, and the driving force by the interaction between the second driving magnet 2242 and the second coil 1152, it can be driven with a greater driving force than when it is driven by one driving magnet and one coil.

Hereinafter, a lens driving device according to a second modified embodiment will be described with reference to the drawings. The description of the same contents as the above embodiment in relation to the modified embodiment may be omitted below.

The lens driving device 10 according to a second modified embodiment may include a fixing part 5100.

The fixing part 5100 may be a stator. The fixing part 5100 may be a relatively fixed part when the movement part 5200 moves. The fixing part 5100 may include the first side plate 5121, a second side plate 5122 arranged in a direction opposite to the first side plate 5121, a third side plate 5122 connected to the first side plate 5121 and the second side plate 5122, and a fourth side plate 5124 arranged in a direction opposite to the first side plate 5121 and the second side plate 5122.

The first side plate 5121 may include a first protruded portion 5131. The first protruded portion 5131 may be protruded from an inner surface of the first side plate 5121 to an inner side of the fixing part 5100. The first protruded portion 5131 may be arranged at a corner region between the first side plate 5121 and the third side plate 5123. The third side plate 5123 may include a second protruded portion 5132. The second protruded portion 5132 may be protruded from an inner surface of the third side plate 5123 to an inner side of the fixing part 5100. The second protruded portion 5132 may be arranged at a corner region between the first side plate 5121 and the third side plate 5123.

The lens driving device 10 according to a second modified embodiment may include a movement part 5200.

The movement part 5200 may include a first side surface 5211, a second side surface 5212 arranged in an opposite direction of the first side surface, a third side surface 5213, connected to the first side surface 5211 and the second side surface 5212, connected to the first side surface 5211 and the second side surface 5212, connected to the first side surface 5211, and a fourth side surface 5214 arranged in an opposite direction of the third side surface 5213.

The first side surface 5211 may include a first groove. The first groove may be arranged at a position corresponding to the first protruded portion 5131 of the first side plate 5121. The first protruded portion 5131 may be arranged in the first groove. The first ball 5310 may be arranged in the first groove.

A first driving magnet may be arranged on the first side surface 5211. The first driving magnet may be arranged to be overlapped with the first yoke 5410 in a direction perpendicular to the optical axis. The first driving magnet may be arranged to be overlapped with the first coil arranged on the first side plate 5121 in a direction perpendicular to the optical axis.

The third side surface 5213 may include a second groove. The second groove may be arranged at a position corresponding to the second protruded portion 5132 of the third side plate 5123. The second protruded portion 5132 may be arranged in the second groove. A second ball 5320 may be arranged in the second groove.

A second driving magnet may be arranged on the third side surface 5213. The second driving magnet may be arranged to be overlapped with the second yoke 5420 in a direction perpendicular to the optical axis. The second driving magnet may be arranged to be overlapped with the second coil being arranged on the third side plate 5123 in a direction perpendicular to the optical axis.

A lens driving device 10 according to a second modified embodiment may include a first ball 5310 and a second ball 5320.

The first ball 5310 and the second ball 5320 may be arranged at a corner region between the first side plate 5121 and the third side plate 5123. The first ball 5310 and the second ball 5320 may be arranged to be spaced apart from each other.

A lens driving device 10 according to a second modified embodiment may include yokes 5410 and 5420. The yokes 5410 and 5420 may include a first yoke 5410. The first yoke 5410 may be arranged to be overlapped with the first driving magnet arranged on the first side surface 5211 in a direction perpendicular to the optical axis direction. The yokes 5410 and 5420 may include a second yoke 5420. The second yoke 5420 may be arranged to be overlapped with the second driving magnet arranged on the third side surface 5213, in a direction perpendicular to the optical axis direction.

The movement part 5200 may move a predetermined distance in a direction of a first corner region by a magnetic force acting between the first yoke 5410 and the first driving magnet arranged on the first side surface 5211 and a magnetic force acting between the second yoke 5420 and the second driving magnet arranged on the third side surface 5213. The movement part 5200 may be moved by a predetermined distance in a direction of a first corner region by the magnetic force acting between the first yoke 5410 and the first driving magnet being arranged on the first side surface 5211 and the second driving magnet being arranged on the second yoke 5420 and the third side surface 5213. In this case, the first corner region may be a region in which the first side plate 5121 and the third side plate 5123 are connected. The first corner region may be a region between the first side plate 5121 and the third side plate 5123.

Since the movement part 5200 is in close contact with the first corner region inside the fixing part 5100, the movement part 5200 may be stably supported by the first ball 5310 and the second ball 5320 arranged between the movement part 5200 and the fixing part 5100.

Since the movement part 5200 is in close contact with a first corner region inside the fixing part 5100 and is supported by the first ball 5310 and the second ball 5320, the movement part 5200 can move stably in an optical axis direction inside the fixing part 5100. Furthermore, since the movement part 5200 is driven by a driving force by the interaction between the first driving magnet and the first coil and a driving force by the interaction between the second driving magnet and the second coil, it can be driven with a greater driving force than when it is driven by one driving magnet and one coil.

Hereinafter, the auto-focus (AF) driving of the lens driving device 10 will be described with reference to the drawings.

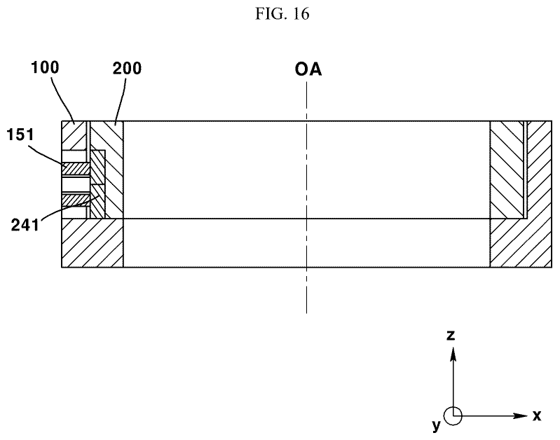

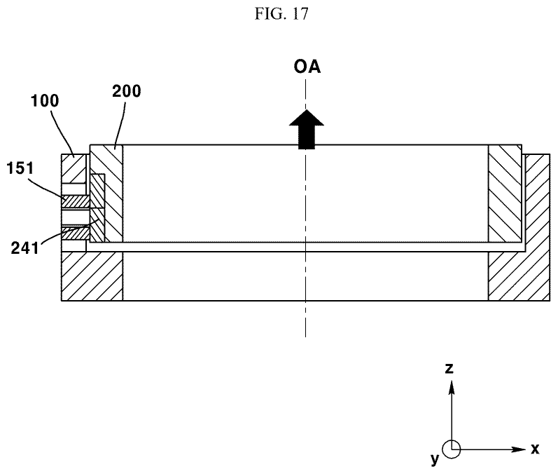

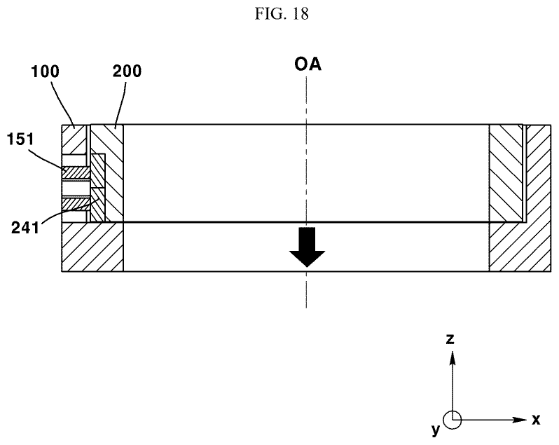

FIGS. 16 to 18 are diagrams for explaining the auto focus driving of a lens driving device according to the present embodiment. FIG. 16 is a cross-sectional view illustrating the appearance of a movement part in an initial state in which no current is applied to a first coil and a second coil. FIG. 17 is a cross-sectional view illustrating the appearance in which a movement part moves upward in an optical axis direction when a forward current is applied to a first coil and a second coil. FIG. 18 is a cross-sectional view illustrating the appearance in which a movement part moves downward in an optical axis direction with reference to the position of a movement part in FIG. 17 when a reverse current is applied to a first coil and a second coil.

The movement part may be arranged on a lower plate 110 of the fixing part 100 at an initial position where no current is applied to the first coil 151 and the second coil 152.

When a forward current is applied to the first coil 151, the first driving magnet 241 may move upward in an optical axis direction by the electromagnetic interaction between the first coil 151 and the first driving magnet 241. When a forward current is applied to the second coil 152, the second driving magnet 242 may move upward in an optical axis direction by the electromagnetic interaction between the second coil 152 and the second driving magnet 242. At this time, the movement part 200 may move upward in an optical axis direction together with the first driving magnet 241 and the second driving magnet 242. Furthermore, the lens of the lens hole 111 may move upward in an optical axis direction together with the movement part 200. Accordingly, the distance between the lens and the image sensor is changed so that a focus of an image being formed on the image sensor through the lens can be adjusted.

When a reverse current is applied to the first coil 151, the first driving magnet 241 may move downward in an optical axis direction by the electromagnetic interaction between the first coil 151 and the first driving magnet 241. When a reverse current is applied to the second coil 152, the second driving magnet 242 may move downward in an optical axis direction by an electromagnetic interaction between the second coil 152 and the second driving magnet 242. At this time, together with the first driving magnet 241 and the second driving magnet 242, the movement part 200 may move downward in an optical axis direction. Furthermore, the lens of the lens hole 111 may move downward in an optical axis direction together with the movement part 200. Accordingly, a distance between the lens and the image sensor is changed so that a focus of an image being formed on the image sensor through the lens may be adjusted.

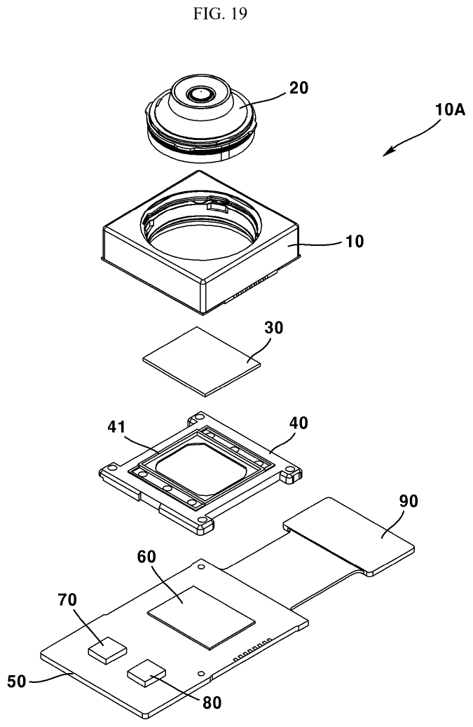

FIG. 19 is an exploded perspective view of a camera device according to the present embodiment.

The camera device 10A may include a lens module 20. The lens module 20 may include at least one lens. The lens may be arranged at a position corresponding to the image sensor 60. The lens module 20 may include a lens and a barrel.

The camera device 10A may include a filter 30. The filter 30 may block light of a specific frequency band from passing through the lens module 20 from being incident on the image sensor 60. The filter 30 may be arranged parallel to an x-y plane. The filter 30 may be arranged between the lens module 20 and the image sensor 60. The filter 30 may be arranged in the sensor base 40. In a modified embodiment, the filter 30 may be arranged in the base 110. The filter 30 may include an infrared filter. The infrared filter may block light in an infrared region from being incident on the image sensor 60.

The camera device 10A may include a sensor base 40. The sensor base 40 may be arranged between the lens driving device 10 and the printed circuit board 50. The sensor base 40 may include a protruded portion 41 in which a filter 30 is arranged. An opening may be formed in a portion of the sensor base 40 in which the filter 30 is arranged so that light passing through the filter 30 may be incident on the image sensor 60. The adhesive member may couple or attach the base 110 of the lens driving device 10 to the sensor base 40. The adhesive member may additionally serve to prevent foreign substances from being introduced into the interior of the lens driving device 10. The adhesive member may include any one or more among epoxy, a thermosetting adhesive, and an ultraviolet-curable adhesive.

The camera device 10A may include a printed circuit board (PCB) 50. The printed circuit board 50 may be a substrate or a circuit board. A lens driving device 10 may be arranged on the printed circuit board 50. A sensor base 40 may be arranged between the printed circuit board 50 and the lens driving device 10. The printed circuit board 50 may be electrically connected to the lens driving device 10. An image sensor 60 may be arranged on the printed circuit board 50. Various circuits, elements, control units, and the like may be provided on the printed circuit board 50 to convert an image formed on the image sensor 60 into an electrical signal and transmit it to an external device.

The camera device 10A may include an image sensor 60. The image sensor 60 may be configured such that light passing through a lens and a filter 30 is incident thereon to an image. The image sensor 60 may be mounted on a printed circuit board 50. The image sensor 60 may be electrically connected to the printed circuit board 50. For example, the image sensor 60 may be coupled to the printed circuit board 50 by surface mounting technology (SMT). As another example, the image sensor 60 may be coupled to the printed circuit board 50 by flip chip technology. The image sensor 60 may be arranged such that its optical axis is aligned with that of the lens. That is, the optical axis of the image sensor 60 and the optical axis of the lens may be aligned. The image sensor 60 can convert light irradiated onto the effective image area of the image sensor 60 into an electrical signal. The image sensor 60 can be any one among a charge coupled device (CCD), a metal oxide semi-conductor (MOS), a CPD, and a CID.

The camera device 10A may include a motion sensor 70. The motion sensor 70 may be mounted on a printed circuit board 50. The motion sensor 70 may be electrically connected to a control unit 80 through a circuit pattern provided on the printed circuit board 50. The motion sensor 70 may output rotational angular velocity information due to the movement of the camera device 10A. The motion sensor 70 may include a two-axis or three-axis gyro sensor, or an angular velocity sensor.

The camera device 10A may include a control unit 80. The control unit 80 may be arranged on a printed circuit board 50. The control unit 80 may be electrically connected to a coil of a lens driving device 10. The control unit 80 may individually control the direction, intensity, amplitude, and the like of the current being supplied to the coil. The control unit 80 may control the lens driving device 10 to perform an auto focus function and/or a hand shake correction function. Furthermore, the control unit 80 may perform auto focus feedback control and/or hand shake correction feedback control for the lens driving device 10.

The camera device 10A may include a connector 90. The connector 90 may be electrically connected to a printed circuit board 50. The connector 90 may include a port for electrically connecting to an external device.

Hereinafter, an optical instrument according to the present embodiment is described with reference to drawings.

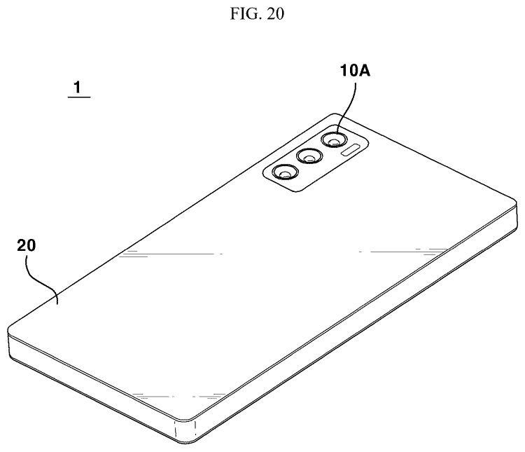

FIG. 20 is a perspective view of an optical instrument according to the present embodiment.

The optical instrument 1 may include at least one among a mobile phone, a cellular phone, a portable terminal, a mobile terminal, a smart phone, a smart pad, a portable smart device, a digital camera, a laptop computer, a digital broadcasting terminal, a Personal Digital Assistants (PDA), a portable multimedia player (PMP), and a navigation device. The optical instrument 1 may include any device for photographing videos or pictures.

The optical instrument 1 may include a main body 20. The optical instrument 1 may include a camera device 10A. The camera device 10A may be arranged in the main body 20. The camera device 10A may photograph a subject. The optical apparatus 1 may include a display. The display may be arranged in the main body 20. The display may output one or more of an image and a video photographed by the camera device 10A. The display may be arranged on a first surface of the main body 20. The camera device 10A may be arranged on one or more of the first surface of the main body 20 and the second surface opposite to the first surface. As illustrated in FIG. 20, in the camera device 10A, a triple camera may be arranged in a vertical direction. As illustrated in FIG. 23, in the camera device 10A, a triple camera may be arranged in a horizontal direction.

Although the embodiment of the present invention has been described above with reference to the accompanying drawings, those of ordinary skill in the art to which the present invention belongs will understand that the present invention may be embodied in other specific forms without changing the technical spirit or essential features thereof. Therefore, it should be understood that the embodiments described above are illustrative in all respects and not restrictive.

1. A lens driving device comprising:
a fixing part;
a movement part disposed inside the fixing part;
a driving magnet disposed on the movement part;
a coil disposed on the fixing part to correspond to the driving magnet; and
a ball disposed between the fixing part and the movement part,—wherein the ball guides the movement part to move in an optical axis direction against the fixing part,
wherein the fixing part comprises a first side plate and a second side plate disposed opposite to each other, a third side plate and a fourth side plate connecting the first and second side plates and disposed opposite to each other,
wherein the first side plate comprises a first protruded portion protruded from an inner surface of the first side plate,
wherein the first protruded portion comprises a plurality of steps, and
wherein the ball comprises a first ball disposed on a stepped region of the plurality of steps of the first protruded portion.

2. The lens driving device according to claim 1,
wherein the movement part comprises a first side surface and a second side surface disposed opposite to each other, and a third side surface and a fourth side surface connecting the first side surface and the second side surface and disposed opposite to each other, and
wherein the driving magnet comprises a first driving magnet disposed on the first side surface of the movement part, and a second driving magnet disposed on the third side surface of the movement part.

3. The lens driving device according to claim 1,
wherein the third side plate comprises a second protruded portion protruded from an inner surface of the third side plate,
wherein the second protruded portion comprises a groove, and
wherein the ball comprises a second ball disposed in the groove of the third side plate.

4. The lens driving device according to claim 3,
wherein the first side surface comprises a first groove formed inwardly of the moving part on the surface of the first side surface, and
wherein the third side surface comprises a second groove formed inwardly of the moving part on the surface of the third side surface.

5. The lens driving device according to claim 4,
wherein the first protruded portion of the first side plate is disposed in the first groove of the first side surface, and
wherein the second protruded portion of the third side plate is disposed in the second groove of the third side surface.

6. The lens driving device according to claim 5,
wherein the first ball is in contact with the first protruded portion of the first side plate and the first groove of the first side surface, and
wherein the second ball is in contact with the second protruded portion of the third side plate and the second groove of the third side surface.

7. The lens driving device according to claim 1 comprising:
a first yoke disposed on the outside of the fixed portion and overlapped with the first side plate in a direction perpendicular to the optical axis direction; and
a second yoke disposed on the outside of the fixed portion and overlapped with the third side plate in a direction perpendicular to the optical axis direction.

8. The lens driving device according to claim 1,
wherein the first ball comprises a plurality of first balls, and
wherein the plurality of first balls is disposed in the optical axis direction.

9. A lens driving device comprising:
a fixing part;
a movement part disposed inside the fixing part;
a driving magnet disposed on the movement part;
a coil disposed on the fixing part to correspond to the driving magnet; and
a ball disposed between the fixing part and the movement part,—wherein the ball guides the movement part to move in an optical axis direction against the fixing part,
wherein the fixing part includes a first side plate and a second side plate disposed opposite to each other, a third side plate and a fourth side plate connecting the first and second side plates and disposed opposite to each other,
wherein the movement part comprises a first side surface and a second side surface disposed opposite to each other, and a third side surface and a fourth side surface connecting the first side surface and the second side surface and disposed opposite to each other,
wherein the first to fourth side plates face the first to fourth side surfaces,
wherein the driving magnet is configured to move the movement part in the optical axis direction via the interaction with the coil,
wherein the ball includes a first ball disposed in a first corner region where the first side plate and the third side plate of the fixing part are connected, and a second ball disposed in a second corner region where the second side plate and the fourth side plate of the fixing part are connected,
wherein the first side plate comprises a first protruded portion protruded from an inner surface of the first side plate,
wherein the first protruded portion comprises a groove,
wherein the groove of the first protruded portion comprises a plurality of steps, and
wherein the first ball is disposed on a stepped region of the groove of the plurality of steps of the first protruded portion.

10. The lens driving device according to claim 9,
wherein the second side plate includes a second protruded portion protruded from the inner surface of the second side plate.

11. The lens driving device according to claim 10,
wherein the second protruded portion of the second side plate comprises a groove,
wherein the groove of the second protruded portion comprises a plurality of steps, and
wherein the second ball is disposed on a stepped region of the groove of the plurality of steps of the second protruded portion.

12. The lens driving device according to claim 10,
wherein the first protruded portion of the first side plate and the second protruded portion of the second side plate is rotationally symmetrical with respect to an optical axis.

13. The lens driving device according to claim 10,
wherein the driving magnet comprises a first driving magnet disposed on the first side surface of the movement part, and a third driving magnet disposed on the third side surface of the movement part.

14. The lens driving device according to claim 9,
wherein the first side surface comprises a groove inwardly recessed from an outer surface of the first side surface toward the inside of the movement part, and
wherein the protruded portion of the first side plate is disposed the groove of the first side surface.

15. The lens driving device according to claim 9,
wherein the second side surface comprises a groove inwardly recessed from an outer surface of the second side surface toward the inside of the movement part, and
wherein the protruded portion of the second side plate is disposed in the groove of the second side surface.

16. The lens driving device according to claim 9 comprising:
a first yoke disposed on an outside of the fixed portion and overlapping the first side plate in a direction perpendicular to the optical axis direction.

17. The lens driving device according to claim 9 comprising:
a second yoke disposed on the outside of the fixed portion and overlapped with the second side plate in a direction perpendicular to the optical axis direction.

18. The lens driving device according to claim 16,
wherein the center of the first yoke is overlapped with a first region of the movement part in a direction perpendicular to the optical axis direction.

19. The lens driving device according to claim 10,
wherein the first ball includes a plurality of first balls, and
wherein the plurality of first balls is disposed in the optical axis direction.

20. The lens driving device according to claim 10,
wherein the first ball comprises a plurality of first balls, and
wherein the plurality of first balls is disposed in the optical axis direction.
